(19) United States
(12) Patent Application Publication
(10) Pub. No.: US 2008/0011017 A1
(43) Pub. Date: Jan. 17, 2008

(54) Method for fabricating a glass substrate for an information recording medium and magnetic disk

(76) Inventors: Hideki Kawai, Kobe-shi (JP); Yukitoshi Nakatsuji, Osaka (JP); Hiroaki Sawada, Osaka (JP); Shinichi Saeki, Osaka (JP)

Correspondence Address: BRINKS HOFER GILSON & LIONE, P.O. BOX 10395, CHICAGO, IL, 60610, US

(21) Appl. No.: 11/824,769

(22) Filed: Jul. 2, 2007

(30) Foreign Application Priority Data
Jul. 3, 2006 (JP) 2006-183087

(51) Int. Cl. C03C 19/00

(52) U.S. Cl. 65/61

(57) ABSTRACT

A method for fabricating a glass substrate for an information recording medium ensures removal of an abrasive or foreign mater adhered to the glass substrate after a polishing step, and involves, after the polishing step, keeping the surface of the glass substrate in contact with a liquid for 10 minutes or more before a scrub-cleaning step. To ensure that the abrasive or foreign matter firmly adhered to the glass substrate is removed by scrub-cleaning, preferably, the surface of the glass substrate is kept in contact with the liquid with the glass substrate immersed in the liquid which is collected.

This application is based on Japanese Patent Application No. 2006-183087 filed on Jul. 3, 2006, the contents of which are hereby incorporated by reference.

### BACKGROUND OF THE INVENTION

1. Field of the Invention

The present invention relates to a method for fabricating a glass substrate and to a magnetic disk, and more particularly to a method for fabricating a glass substrate for an information recording medium which includes a step of polishing the glass substrate and a step of cleaning the polished glass substrate by scrubbing and a magnetic disk utilizing the glass substrate.

2. Description of Related Art

Conventionally, as substrates for magnetic disks, there have generally been used aluminum substrates in stationary devices such as desktop computers and servers, and glass substrates in portable devices such as notebook computers and mobile computers. One disadvantage with aluminum substrates is that they are easy to deform and are not hard enough, offering not quite satisfactory smoothness on the substrate surface after polishing. Another disadvantage is that, if a magnetic head happens to touch a magnetic disk, the magnetic film on an aluminum substrate is prone to exfoliate from the substrate. Under this background, it is expected that glass substrates, less prone do deformation, offering better surface smoothness, and affording higher mechanical strength, will be increasingly used not only in portable but also in stationary devices and in other home information appliances.

The recording capacity of a magnetic disk can be increased by reducing the distance between the surface thereof and a magnetic head. Inconveniently, however, with a reduced distance between a magnetic head and the surface of a magnetic disk, if there is an abnormal projection formed on or foreign matter adhered to the surface of a glass substrate, the magnetic head collides with the projection or foreign matter. Thus, to make it possible to increase the recording capacity of a magnetic disk by reducing the distance from the surface thereof to a magnetic head, it is necessary to eliminate formation of projections on and adhesion of foreign matter to the surface of a glass substrate altogether. For this purpose, it is conventional practice to polish the surface of a glass substrate with an abrasive such as cerium oxide to make it smooth enough.

Disadvantageously, however, polishing a glass substrate with an abrasive may leave the abrasive firmly adhered to the surface thereof, and even when the glass substrate surface is thereafter cleaned by scrubbing, it is difficult to remove the abrasive firmly adhered thereto. Moreover, forming a magnetic recording layer on the glass substrate surface with the abrasive firmly adhered thereto is likely to produce pin holes in the layer, destabilize the floating characteristics of the head, and otherwise significantly degrade the magnetic recording characteristics.

As a solution, for example, JP-A-2002-074653 proposes performing, after a polishing step, three types of cleaning, namely ultrasonic cleaning using a detergent, cleaning by scrubbing, and ultrasonic cleaning using pure water. As another solution, JP-A-2003-228824 proposes cleaning a glass substrate by a combination of cleaning by scrubbing and clearing using a water solution of carbon dioxide.

Supposedly, these conventionally proposed technologies help to a certain degree to remove the abrasive adhered to a glass substrate. Disadvantageously, however, the former technology, requiring three types of cleaning, complicates the cleaning step and lowers productivity; likewise, the latter technology, requiring the introduction of equipment for maintaining and managing the solubility of the gas, complicates the cleaning step and lowers productivity.

### SUMMARY OF THE INVENTION

In view of the above described problems, it is an object of the present invention to provide a method for fabricating a glass substrate that, without requiring a complicated cleaning step, ensures removal of an abrasive and foreign matter adhered to a glass substrate after a polishing step and leaves the glass substrate after the cleaning step clean and free of residual detergent ingredients.

Another object of the present invention is to provide a magnetic disk that allows the recording capacity thereof to be increased through a reduction of the distance between a magnetic head and the surface of the magnetic disk.

According to one aspect of the present invention, a method for fabricating a glass substrate for an information recording medium including: a step of polishing the glass substrate; and a step of cleaning the polished glass substrate by scrubbing. Here, the method is characterized by that after the step of polishing, the surface of the glass substrate is kept in contact with a liquid for duration of 10 minutes or more before the step of cleaning by scrubbing, is provided.

Here, to ensure that an abrasive and foreign matter firmly adhered to the glass substrate is removed by scrub-cleaning, it is preferable that the surface of the glass substrate is kept in contact with the liquid with the glass substrate immersed in the liquid which is collected.

It is preferable that the glass substrate contain SiO₂ as a main ingredient thereof. It is preferable that the liquid has a pH in the range from 3 to 11, and more preferably in the range from 4 to 10; and the liquid may even have a pH approximately equal to 7.

According to another aspect of the present invention, a magnetic disk having a magnetic recording layer formed on a glass substrate fabricated by the method described above, is provided.

With a method for fabricating a glass substrate according to the present invention, after a step of polishing, the surface of the glass substrate is kept in contact with a liquid for 10 minutes or more before the step of cleaning by scrubbing. This allows the glass substrate surface to be slightly eroded, and thereby allows an abrasive and foreign matter firmly adhered to the glass substrate surface to somewhat float, ensuring removal the abrasive and foreign matter by scrub-cleaning. Moreover, keeping the glass substrate in contact with the liquid helps prevent an abrasive from firmly adhering to the glass substrate during drying after the polishing step, and thus helps prevent adhesion of additional foreign matter to the glass substrate surface.

By keeping the surface of the glass substrate in contact with the liquid with the glass substrate immersed in the liquid which is collected, it is possible to more effectively ensure removal of an abrasive and foreign matter firmly adhered to the glass substrate by scrub-cleaning.

Using as the glass substrate one containing SiO₂ as a main ingredient thereof helps more easily obtain the benefits of the present invention.

With a magnetic disk according to the present invention, which has a magnetic recording layer formed on a glass substrate fabricated by the method described above, it is possible to reduce the distance between a magnetic head and the surface of the magnetic disk, and thus to increase the recording capacity.

### BRIEF DESCRIPTION OF THE DRAWINGS

FIG. 1 is a diagram to show an example of a process, according to the present invention, for fabricating a glass substrate and a magnetic disk.

### DETAILED DESCRIPTION OF PREFERRED EMBODIMENTS

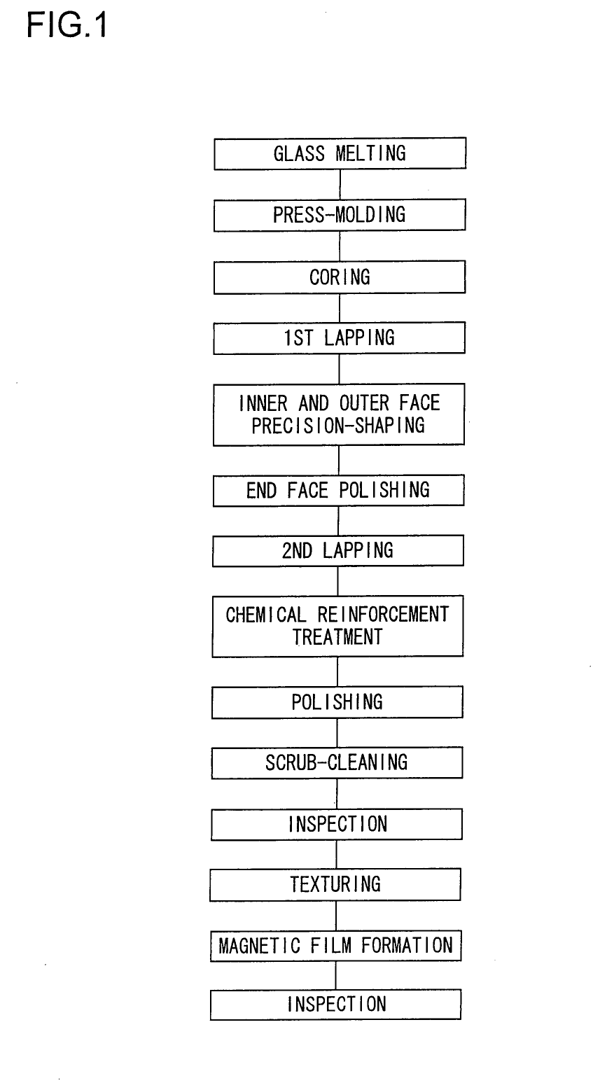

FIG. 1 shows an outline of, in one part, an example of a process for fabricating a glass substrate involving, between a polishing step and a scrub-cleaning step, keeping the glass substrate in contact with a liquid according to the present invention and, in the other part, an example of a process for fabricating a magnetic disk using the so fabricated glass substrate. First, a glass material is melted (a glass melting step). The melted glass is then poured into a lower mold, and is then molded by being pressed with an upper mold into a disk-shaped glass substrate precursor (a press-molding step). Here, the disk-shaped glass substrate precursor may be formed, instead of by press-molding, by cutting it with an abrasive grindstone out of sheet glass formed, for example, by down-drawing or floating.

There is no particular restriction on the material of the glass substrate of the present invention. Examples of the material include: soda-lime glass, of which the main ingredients are silicon dioxide, sodium oxide, and calcium oxide; aluminosilicate glass, of which the main ingredients are silicon dioxide, aluminum oxide, and R₂O (where R=K, Na, Li); borosilicate glass; lithium oxide-silicon dioxide glass; lithium oxide-aluminum oxide-silicon dioxide glass; R′O-aluminum oxide-silicon dioxide glass (where R′=Mg, Ca, Sr, Ba). Any of these glass materials may have zirconium oxide, titanium oxide, or the like added thereto. The present invention is suitably applicable particularly to a glass material containing 50% by weight or more of SiO₂.

There is no particular restriction on the size of the glass substrate. The method of the present invention is applicable to 2.5-inch, 1.8-inch, 1-inch, and 0.85-inch disks and even disks with smaller diameters, and to 2 mm thick, 1 mm thick, and 0.63 mm thick disks and even disks with smaller thicknesses.

As necessary, in a central portion of the press-molded glass substrate precursor, a hole is formed with a core drill or the like (a coring step). Then, in a first lapping step, the surface of the glass substrate on both sides is ground, and thereby the overall shape of the glass substrate is preliminarily adjusted in terms of the parallelism, flatness, and thickness thereof. Next, the edges of the outer and inner circumferential faces of the glass substrate are ground and chamfered, and thereby fine adjustments are made in the exterior dimensions and roundness of the glass substrate, the inner diameter of the hole, and the concentricity between the glass substrate and the hole (an inner and outer face precision-shaping step). Then, the outer and inner circumferential faces of the glass substrate are polished to remove minute scratches and the like (an end face polishing step).

Next, the surface of the glass substrate on both sides is ground again, and thereby fine adjustments are made in the parallelism, flatness, and thickness of the glass substrate (a second lapping step). Then, to improve the mechanical strength of the glass substrate, it is subjected to chemical reinforcement treatment. In the chemical reinforcement treatment here, the glass substrate is immersed in a chemical reinforcement liquid stored in a chemical reinforcement treatment vat so that the alkali metal ions on the glass substrate surface are substituted by alkali metal ions with larger ion diameters. This produces compression strain and thereby improves mechanical strength.

Next, the surface of the glass substrate on both sides is polished, and thereby the surface irregularities on the glass substrate surface are leveled. As necessary, the surface of the glass substrate on both sides may be further polished with an abrasive with a different grain size.

One of the distinctive features of the fabrication method of the present invention is that the glass substrate after the polishing step is kept in contact with a liquid having a pH in a predetermined range for a predetermined duration or longer. This allows an abrasive and foreign matter firmly adhered to the glass substrate surface to somewhat float, and thereby ensures removal the abrasive or foreign matter by scrub-cleaning in the next step. Moreover, since the glass substrate is brought into contact with the liquid immediately after the polishing step, it is possible to effectively prevent adhesion of foreign matter to the glass substrate after the polishing step.

As the liquid used in the present invention, a neutral liquid suffices to allow the abrasive and foreign matter adhered to the glass substrate to somewhat float, but it may be acidic or alkaline. The range of the pH of the liquid is from 3 to 11. If the liquid has a pH smaller than 3, the excessive acidity causes corrosion in the environment around cleaning and other equipment, necessitating the introduction of exhaust equipment and complicating the maintenance and management of the liquid. On the other hand, if the liquid has a pH larger than 11, the liquid is so reactive with glass that it excessively erodes the glass substrate surface and degrades the quality of the glass substrate. A more preferable range of the pH of the liquid is from 4 to 10. Examples of the liquid used in the present invention include: a detergent, ultrapure water, ion water, activator-containing water, a weakly alkaline solution, a weakly acidic solution, ozone water, a neutral detergent liquid, and hydrogen peroxide water.

Moreover, according to the present invention, the glass substrate is kept in contact with the liquid for duration of 10 minutes or more. With the duration of the contact of the glass substrate with the liquid less than 10 minutes, the liquid erodes the glass substrate surface too little to allow the abrasive and foreign matter firmly adhered thereto to sufficiently float. This makes it impossible to remove the abrasive and foreign matter from the glass substrate surface completely by scrub-cleaning. Here, the longer the duration of the contact of the glass substrate with the liquid, the easier the removal of the abrasive and foreign matter from the glass substrate surface, but the lower the productivity of the glass substrate. Thus, a more preferable range of the duration of contact is from 10 minutes to 100 minutes. For effective prevention of adhesion of foreign matter to the glass substrate surface, it is recommended that the glass substrate be kept in contact with the liquid from immediately after polishing until immediately before scrub-cleaning.

As the method for keeping the glass substrate surface with the liquid, any conventionally known one may be adopted. Examples of such methods include: one in which the glass substrate is immersed in the liquid which is collected; one in which the glass substrate is sprayed with the liquid; and one in which the glass substrate is coated with cloth impregnated with the liquid. Among these, the method involving immersion of the glass substrate in the liquid is preferable because it ensures that the entire glass substrate surface is evenly kept in contact with the liquid. After the glass substrate is immersed in a predetermined liquid for a predetermined duration, it is then cleaned by scrubbing to remove the abrasive and foreign matter adhered to the surface thereof.

In the present invention, the step of polishing the glass substrate and the step of cleaning it by scrubbing are achieved with conventionally known technologies as they are. To polish the glass substrate, for example, two rotatable surface plates are arranged opposite each other, and pads are attached one to each of the faces thereof that face each other; then, the glass substrate is placed between the two pads, and the surface plates are rotated with the glass substrate surface kept in contact with the pads, while an abrasive is supplied to the glass substrate surface. Examples of the abrasive include: cerium oxide, zirconium oxide, aluminum oxide, manganese oxide, colloidal silica, and diamond. Among these, using cerium oxide is recommendable because it reacts well with glass and produces a smooth polished surface in a short time.

On the other hand, to perform scrub-cleaning, for example, the glass substrate is held between a pair of sponge rollers, and the sponge rollers are rotated in opposite directions relative to each other, while a detergent is supplied; simultaneously, the glass substrate surface itself is also moved up and down; thus, the entire surface of the glass substrate on both sides is cleaned. Scrubbing may be achieved with any other members than sponge rollers, such as brushes or pads. Examples of the material of such scribing members include: polyvinyl alcohol, polyurethane, vinyl alcohol, polypropylene, and nylon.

As necessary, the glass substrate that has undergone scrub-cleaning is then subjected to drying (unillustrated). Specifically, for drying, the glass substrate is immersed in IPA (isopropyl alcohol) so that detergent ingredients dissolve into IPA and that the liquid coating the substrate surface is substituted by IPA; thereafter, while the glass substrate is exposed to IPA vapor, IPA is vaporized and thereby the glass substrate is dried. The glass substrate may be dried otherwise than just described; it may be dried by any conventionally known method as one for drying a glass substrate, such as spin drying and air-knife drying. Thereafter, as necessary, the glass substrate is inspected.

Next, the glass substrate is subjected to texturing. In the texturing here, stripes in the shape of concentric circles are formed on the glass substrate surface by polishing using tape. Texturing gives a magnetic disk magnetic anisotropy; this improves the magnetic characteristics thereof as a magnetic disk, and also prevents attraction between a magnetic head and the surface of the magnetic disk when a hard disk drive is out of operation.

Here, a texturing liquid is used that has abrasive particles dispersed evenly in a liquid in a way that the abrasive particles do not precipitate while the liquid is in storage. An example of such a texturing liquid is slurry having about 0.01% to 5% by weight of abrasive particles dispersed in a water solution containing about 1% to 25% by weight of a glycol compound surfactant such as polyethylene glycol or polypropylene glycol.

An example of the abrasive particles is monocrystalline or polycrystalline diamond particles. Diamond particles have a regular particles shape, have a uniform particle size and shape, are hard, and are excellently resistant to chemicals and heat. In particular, polycrystalline diamond particles have, compared with monocrystalline counterparts, a more round particle shape, with rounded comers, and are widely used as abrasive particles for ultraprecision polishing.

It is preferable that, after texturing, the topmost surface of the glass substrate has a surface roughness Ra of 0.3 nm or less. In the magnetic disk as an end product, a surface roughness larger than 0.3 nm here makes it impossible to reduce the distance between a magnetic head and the surface of the magnetic disk, and thus to increase the recording capacity of the magnetic disk.

Next, on the glass substrate fabricated as described above, a magnetic film is formed. The magnetic film can be formed by a conventionally known method, for example, by spin-coating the substrate with a thermosetting resin having magnetic particles dispersed therein, by sputtering, or by electroless plating. Spin-coating provides a film thickness of about 0.3 μm to 1.2 μm, sputtering provides a film thickness of about 0.04 μm to 0.08 μm, and electroless plating provides a film thickness of about 0.05 μm to 0.1 μm. To reduce the film thickness and to obtain a high density, it is preferable to adopt sputtering or electroless plating.

There is no particular restriction on the material of the magnetic film; it may be any conventionally known magnetic material. To obtain a high coercivity, it is suitable to use, for example, an alloy of Co that is based on Co, having high crystal anisotropy, and that has Ni or Cr added thereto to adjust the residual flux density. Specifically, examples of such magnetic materials containing Co as a main ingredient thereof include: CoPt, CoCr, CoNi, CoNiCr, CoCrTa, CoPtCr, CoNiPt, CoNiCrPt, CoNiCrTa, CoCrPtTa, CoCrPtB, and CoCrPtSiO. To reduce noise, the magnetic film may be divided with a non-magnetic film (e.g., Cr, CrMo, or CrV) to have a multiple-layer structure (e.g., CoPtCr/CrMo/CoPtCr, CoCrPtTa/CrMo/CoCrPtTa). Other than the magnetic materials mentioned above, it is also possible to use: a ferrite material; an iron-rare earth metal material; or a granular material having magnetic particles of Fe, Co, FeCo, CoNiPt, or the like dispersed in a non-magnetic film of SiO₂, BN, or the like. The magnetic film may be for either of the longitudinal and perpendicular types of recording.

For smoother sliding of a magnetic head, a thin coat of a lubricant may be applied to the surface of the magnetic film. An example of the lubricant is perfluoropolyether (PFPE), a liquid lubricant, diluted with a solvent of the Freon family.

As necessary, an underlayer or a protective layer may additionally be provided. In a magnetic disk, what underlayer to provide is determined to suit the magnetic film. The material of the underlayer is, for example, one or more selected from the group of non-magnetic metals including Cr, Mo, Ta, Ti, W, V, B, Al, and Ni. With a magnetic film containing Co as a main ingredient thereof, it is preferable to use the simple substance of or an alloy of Cr. The underlayer is not limited to one having a single layer, but may be one having a multiple-layer structure having a plurality of layers of the same material or of different materials laid on one another. Examples of multiple-layer underlayers include: Cr/Cr, Cr/CrMo, Cr/CrV, NiAl/Cr, NiAl/CrMo, and NiAl/CrV.

Examples of protective layers for preventing wear and corrosion of the magnetic film include: a Cr layer, a Cr alloy layer, a carbon layer, a carbon hydride layer, a zirconia layer, and a silica layer. Any of these protective layers can be formed continuously with the underlayer, the magnetic film, etc. on in-line sputtering equipment. Any of those protective layers may be provided in a single layer, or more than one of them, of the same material or of different material, may be provided in multiple layers. In addition to, or instead of, this or these protective layers, another protective layer may be formed. For example, instead of the above protective layers, a silicon dioxide (SiO₂) layer may be formed by applying to the top of the Cr layer minute particles of colloidal silica dispersed in tetraalkoxysilane diluted with a solvent of the alcohol family and then baking the applied layer.

### PRACTICAL EXAMPLE 1 (P. Ex. 1)

A substrate of aluminosilicate glass containing as glass ingredients thereof 66% by weight of SiO₂ and 15% by weight of Al₂O₃ was polished, and was then immersed in a weakly acidic liquid having a pH of 6.0 for 30 minutes. The glass substrate was subsequently cleaned on a roll-scrub cleaning machine, and was then dried. The dried glass substrate was then inspected for foreign matter adhered to the glass substrate surface and for surface smoothness. The results are shown in Table 1.

### PRACTICAL EXAMPLE 2 (P. Ex. 2)

A substrate of non-alkali glass containing as glass ingredients thereof 60% by weight of SiO₂, 10% by weight of Al₂O₃, and 10% by weight of B₂O₃ was polished, and was then exposed to a shower of ion water having a pH of 7.2 so that the substrate surface is kept in a state coated with the ion water for 20 minutes. The glass substrate was subsequently cleaned on a roll-scrub cleaning machine, and was then dried. The dried glass substrate was then, as with that of Practical Example 1, inspected for foreign matter adhered to the glass substrate surface and for surface smoothness. The results are shown in Table 1.

### COMPARATIVE EXAMPLE 1 (C. Ex. 1)

A substrate of aluminosilicate glass containing as glass ingredients thereof 66% by weight of SiO₂ and 15% by weight of Al₂O₃ was polished, and was then immersed in sulfuric acid having a pH of 2.0 for 30 minutes. The glass substrate was subsequently cleaned on a roll-scrub cleaning machine, and was then dried. The dried glass substrate was then, as with that of Practical Example 1, inspected for foreign matter adhered to the glass substrate surface and for surface smoothness. The results are shown in Table 1.

### COMPARATIVE EXAMPLE 2 (C. Ex. 2)

A substrate of non-alkali glass containing as glass ingredients thereof 60% by weight of SiO₂, 10% by weight of Al₂O₃, and 10% by weight of B₂O₃ was polished, and was then exposed to a shower of a water solution of NaOH having a pH of 13.0 so that the substrate surface is kept in a state coated with the solution for 20 minutes. The glass substrate was subsequently cleaned on a roll-scrub cleaning machine, and was then dried. The dried glass substrate was then, as with that of Practical Example 1, inspected for foreign matter adhered to the glass substrate surface and for surface smoothness. The results are shown in Table 1.

### COMPARATIVE EXAMPLE 3 (C. Ex. 3)

A substrate of aluminosilicate glass containing as glass ingredients thereof 66% by weight of SiO₂ and 15% by weight of Al₂O₃ was polished, and was then immersed in a weakly acidic liquid having a pH of 6.0 for three minutes. The glass substrate was subsequently cleaned on a roll-scrub cleaning machine, and was then dried. The dried glass substrate was then, as with that of Practical Example 1, inspected for foreign matter adhered to the glass substrate surface and for surface smoothness.

The results are shown in Table 1.

TABLE 1

| | P. Ex. 1 | P. Ex. 2 | C. Ex. 1 | C. Ex. 2 | C. Ex. 3 |
|---|---|---|---|---|---|
| pH of Liquid | 6.0 | 7.2 | 2.0 | 13.0 | 6.0 |
| Duration of Contact | 30 | 20 | 30 | 20 | 3 |
| with Liquid | | | | | |
| Foreign Matter Removal | Good | Good | Poor | Good | Poor |
| from Substrate Surface | | | | | |
| Substrate Surface | Good | Good | Poor | Poor | Good |
| Smoothness after | | | | | |
| Cleaning | | | | | |

With the fabrication methods of Practical Examples 1 and 2 of the present invention, no foreign matter was found adhered to the glass substrate surface after scrub-cleaning, and the surface had good smoothness. In contrast, with the fabrication method of Comparative Example 1, according to which the glass substrate was immersed in a liquid having a pH of 2.0 before scrub-cleaning, the cleaning equipment was corroded by the liquid, and the resulting rust and foreign particles adhered to the glass substrate after cleaning, resulting in the glass substrate having poor surface smoothness. With the fabrication method of Comparative Example 2, according to which the glass substrate was immersed in a liquid having a pH of, conversely, 13.0 before scrub-cleaning, certainly the foreign matter adhered to the glass substrate surface was thoroughly removed, but the glass substrate surface was eroded more than necessary, resulting in poor surface smoothness. With the fabrication method of Comparative Example 3, according to which the glass substrate was kept in contact with a liquid having a pH of 6.0 for as short as three minutes, certainly the glass substrate after cleaning had good smoothness, but foreign matter was found adhered to the glass substrate surface.

What is claimed is:

1. A method for fabricating a glass substrate for an information recording medium, comprising:
a step of polishing the glass substrate; and
a step of cleaning the polished glass substrate by scrubbing,
wherein, after the step of polishing, a surface of the glass substrate is kept in contact with a liquid for duration of 10 minutes or more before the step of cleaning by scrubbing.

2. The method for fabricating a glass substrate according to claim 1,
wherein the surface of the glass substrate is kept in contact with the liquid with the glass substrate immersed in the liquid which is collected.

3. The method for fabricating a glass substrate according to claim 1,
wherein the glass substrate contains SiO₂ as a main ingredient thereof.

4. The method for fabricating a glass substrate according to claim 1,
wherein the liquid has a pH in a range from 3 to 11.

5. The method for fabricating a glass substrate according to claim 1,
wherein the liquid has a pH in a range from 4 to 10.

6. The method for fabricating a glass substrate according to claim 1,
wherein the liquid has a pH approximately equal to 7.

7. The method for fabricating a glass substrate according to claim 1,
wherein the duration for which the surface of the glass substrate is kept in contact with the liquid is 100 minutes or less.

8. A magnetic disk having a magnetic recording layer formed on a glass substrate fabricated by the method according to claim 1.
